(19) United States
(12) Patent Application Publication
(10) Pub. No.: US 2020/0116506 A1
(43) Pub. Date: Apr. 16, 2020

(54) CROWD CONTROL USING INDIVIDUAL GUIDANCE

(71) Applicant: Xinova, LLC, Seattle, WA (US)

(72) Inventor: Ezekiel KRUGLICK, Poway, CA (US)

(73) Assignee: Xinova, LLC, Seattle, WA (US)

(21) Appl. No.: 16/471,593

(22) PCT Filed: Jan. 12, 2017
(86) PCT No.: PCT/US2017/013133

§ 371 Date: Jun. 20, 2019

(51) Int. Cl. G01C 21/34; G06K 9/00; G06K 9/46; H04W 4/024

(52) U.S. Cl. CPC G01C 21/3407; H04W 4/024; G06K 9/46; G06K 9/00778

(57) ABSTRACT

Technologies are generally described for identification and use of attractors in crowd control. In some examples, a crowd guidance system may receive a guidance request relating to a device associated with an individual in a crowd. The crowd guidance system may use information in the guidance request and a model of the crowd to determine one or more visual features that can be used to guide the individual. The crowd guidance system may provide the feature(s) to the device, which may then provide image data indicating the feature(s) to the individual for guidance.

### BACKGROUND

Unless otherwise indicated herein, the materials described in this section are not prior art to the claims in this application and are not admitted to be prior art by inclusion in this section.

Events that draw crowds of people, such as concerts, conventions, and similar events, may involve crowd control planning. For example, security personnel and/or signage may be positioned around or within the event area or location to provide guidance and direction to individuals within the crowds. In some situations, it may be difficult to provide successful crowd guidance and direction, especially if the crowd is large. Moreover, individuals within the interior of the crowd may not be able to easily receive instructions and guidance originating from the crowd periphery.

### SUMMARY

The present disclosure generally describes techniques to provide guidance to individuals within a crowd for crowd control.

According to some examples, a method to provide guidance to individuals for crowd control is provided. The method may include receiving a crowd model for a crowd, receiving a guidance request relating to a device associated with an individual in the crowd, determining at least one target feature in the crowd based on the guidance request and the crowd model, and providing the at least one target feature to the device.

According to other examples, a system to provide guidance to individuals for crowd control is provided. The system may include a communication module configured to exchange data with one or more computing devices, a memory configured to store instructions, and a processor coupled to the communication module and the memory. The processor may be configured to execute a crowd-control application in conjunction with the instructions stored in the memory. The crowd-control application may be configured to receive a crowd model for a crowd, receive a guidance request relating to a device associated with a first individual in the crowd, determine a second individual in the crowd as a target based on the guidance request, the crowd model, and at least one feature associated with the second individual, and provide the at least one feature to the device.

According to further examples, a mobile device configured to provide crowd navigation guidance to an individual is provided. The mobile device may include an imaging module configured to capture image data associated with the individual and a crowd, a memory configured to store instructions, and a processor coupled to the imaging module and the memory. The processor may be configured to execute a guidance application in conjunction with the instructions stored in the memory. The guidance application may be configured to send a request for crowd guidance to a crowd control system, transmit the image data to the crowd control system, receive feature data from the crowd control system, determine at least one feature in the image data based on the received feature data, and add at least one indicator based on the determined feature(s) to the image data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 includes a conceptual illustration of an example crowd;

FIG. 2 illustrates an example crowd monitoring and control system configured to provide guidance to individuals within a crowd;

FIG. 3 illustrates major components of an example system configured to provide guidance to individuals within a crowd;

FIG. 4 depicts conceptually how features may be used to identify and tag individuals within a crowd to use as guides;

FIG. 5 illustrates a general purpose computing device, which may be used to provide guidance to individuals within a crowd;

FIG. 6 is a flow diagram illustrating an example method to provide guidance to individuals within a crowd that may be performed by a computing device such as the computing device in FIG. 5; and

FIG. 7 illustrates a block diagram of an example computer program product, some of which arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to providing guidance to individuals within a crowd for crowd control.

Briefly stated, technologies are generally described to provide guidance to individuals within a crowd for crowd control. In some examples, a crowd guidance system may receive a guidance request relating to a device associated with an individual in a crowd. The crowd guidance system may use information in the guidance request and a model of the crowd to determine one or more visual features that can be used to guide the individual. The crowd guidance system may provide the feature(s) to the device, which may then provide image data indicating the feature(s) to the individual for guidance. The feature(s) may include one or more computer vision features in other examples.

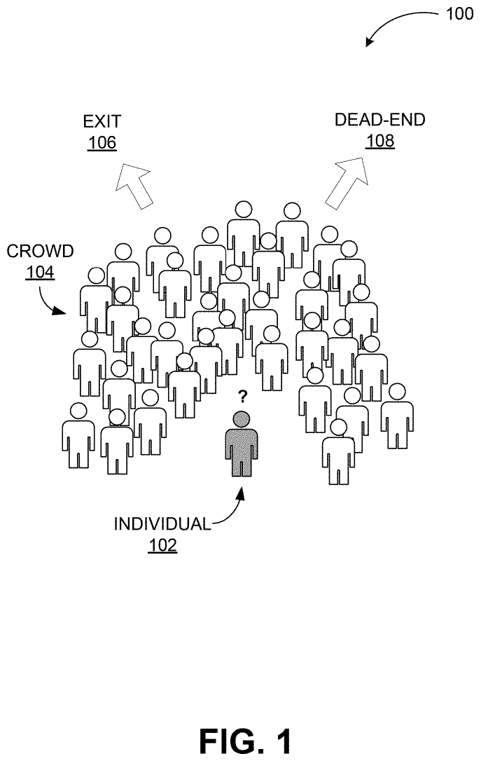

FIG. 1 includes a conceptual illustration of an example crowd.

As depicted in a diagram 100, a crowd 104 may include multiple individuals (e.g., persons), some individuals located near the periphery of the crowd 104, and other individuals located in the middle of the crowd 104. An individual 102 in the middle of the crowd 104 may find it difficult to observe events outside of or beyond the crowd 104. If the crowd 104 is moving, the individual 102 may be unable to determine the destination of the crowd 104 and may be unable to observe events, barriers, and other objects of interest (or hazard) in the direction of movement of the crowd. If the crowd 104 includes multiple groups of individuals moving in different directions, the individual 102 may be unable to determine which direction is more desirable and therefore which group to follow. For example, suppose that some groups within the crowd 104 are moving toward an exit 106 and some groups within the crowd 104 are moving toward a dead-end 108. The individual 102 may wish to follow the groups moving toward the exit 106. However, because the individual 102 is in the middle of the crowd 104, the individual 102 may be unable to determine the direction corresponding to the exit 106, and may be unable to differentiate the groups moving toward the exit 106 from the groups moving toward the dead-end 108.

A crowd as used herein refers to a group of individuals generally moving in a similar direction. In some examples, a group of individuals in a general geographic area may include multiple crowds, that is, different sub-groups moving in different directions. While crowds of people are used as illustrative examples herein, embodiments are not limited to controlling crowds of people. Other crowds such as herds of animals, groups of self-propelled robotic machines, and comparable ones may also be controlled through a crowd monitoring and control system configured to identify and utilize target features in crowd control using the principles described herein. A target as used herein refers to an individual within a crowd and a feature refers to a distinguishing visible element on a target such as a computer vision feature, which may include an opportunistic collection of lines, gradients, or other mathematically representable elements within a field of view.

According to some embodiments, a crowd model of a crowd may provide or be used to determine one or more desired directions for the crowd or for groups within the crowd. To guide individuals or groups within the crowd, one or more targets may be selected as mentioned above. The targets may be selected based on the desired direction(s) for the crowd or the groups within the crowd and the crowd model, which may include one or more of a number of individuals, a direction of each individual, a speed of each individual, a density of the individuals within the crowd, and comparable crowd parameters. If more than one target is available for an individual or a group within the crowd, one may be selected based on visibility, direction of movement, surroundings of the crowd such as barriers, and similar parameters. Alternatively, more than one target may also be provided to the individuals or groups to follow if the multiple targets are all moving in the desired direction.

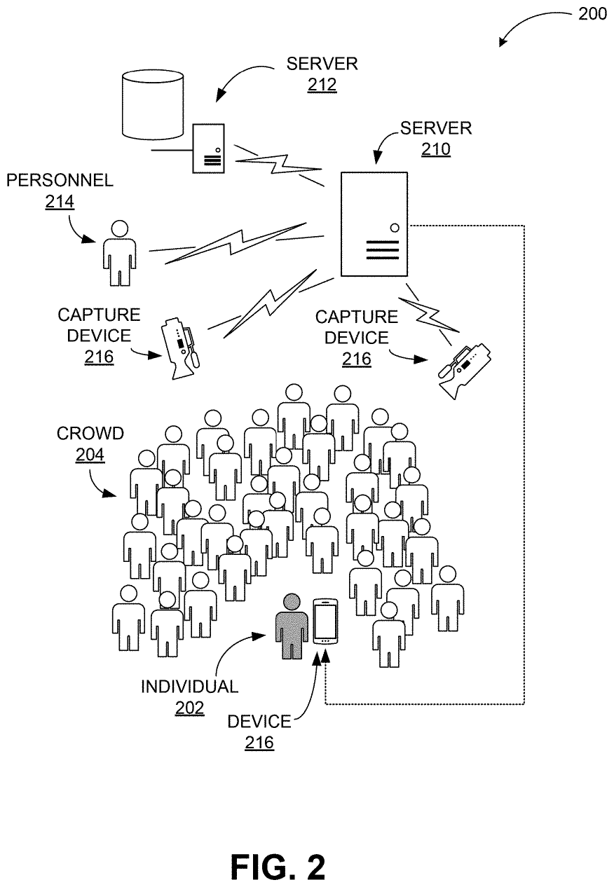

FIG. 2 illustrates an example crowd monitoring and control system 200 configured to provide guidance to individuals within a crowd, arranged in accordance with at least some embodiments described herein.

The crowd monitoring and control system 200 may be configured to monitor a crowd 204, similar to the crowd 104. The crowd monitoring and control system 200 may include a server 210 configured to control the control system 200. The server 210 may be configured to communicate with at least one remote server 212, which may in turn be coupled to one or more databases or other remote devices or systems. For example, the remote server 212 may be configured to provide map data associated with the location of the crowd 204, or may be configured to provide information about individuals within the crowd 204. The server 210 may also be configured to communicate with one or more personnel 214. The personnel 214 may include security personnel distributed within and around the crowd 204 and/or other authorities such as police officers and similar.

The control system 200 may further include one or more image or video capture devices 216 coupled to the server 210. The capture devices 216 may be oriented toward the crowd 204 and/or locations associated with the crowd 204, and may be configured to capture still image and/or video stream data associated with the crowd 204 and transmit the captured data to the server 210. The capture devices 216 may be stationary (for example, mounted to one or more structures) or mobile (for example, mounted to a vehicle or carried by security personnel).

The server 210 may be configured to communicate with one or more devices associated with individuals within the crowd 204. For example, the server 210 may be configured to communicate with a device 206 belonging to or associated with an individual 202 within the crowd 204. The device 206 may include a smart phone, a video camera, a wearable computer, a tablet computer, an augmented reality display device, or any other device capable of providing information to the individual 202. In situations where the individual 202 wants or requires guidance, for example as described above in FIG. 1, the device 206 or an application executing on the device 206 may be configured to transmit a guidance request to the server 210. The server 210 may then be configured to transmit guidance or instructions back to the device 206 for the individual 202. The guidance instructions may indicate, for example, that the individual 202 should proceed in a particular direction and/or at a particular speed or at a particular pace.

The control system 200 may also be coupled to one or more other display or notification devices, which may be associated with personnel 214 and/or particular locations in the area of the crowd 204. The control system 200 may be configured to transmit notification data associated with crowd control and guidance to those devices, and may also be configured to receive location, still images, and/or video streams from those devices.

In some embodiments, the crowd monitoring and control system 200 may be configured to generate guidance for the individual 202 in the crowd 204 based on a guidance request received relating to the device 206, a crowd model of the crowd 204, and other data such as desired crowd flows and similar. For example, the capture devices 216 may capture image or video data associated with the crowd 204 and transmit the captured data to the server 210. The server 210, in conjunction with the remote server 212, may then use the captured data to generate and/or update a model of the crowd 204. Upon receiving a guidance request relating to the device 206, the server 210 may then use the crowd model, the captured image/video data, data in the guidance request, desired crowd flow data, and optionally other information to generate guidance for the individual 202. The guidance may include one or more visual features and/or particular individuals in the crowd 204 for the individual 202 to follow. The server 210 may transmit the guidance to the device 206, which may then present the guidance to the individual 202.

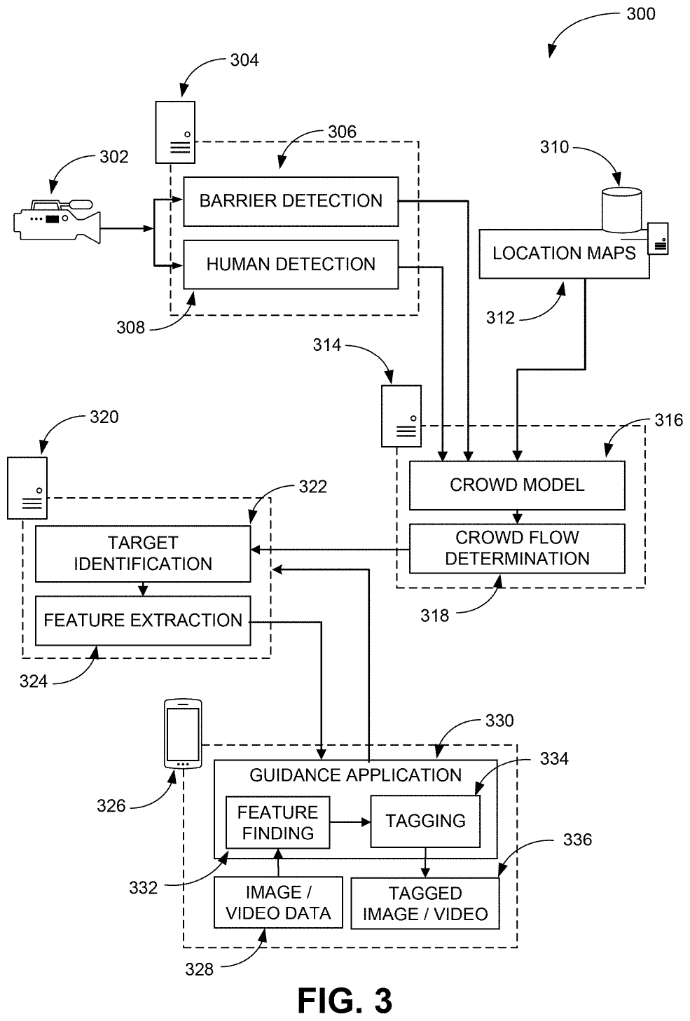

FIG. 3 illustrates major components of an example system configured to provide guidance to individuals within a crowd, arranged in accordance with at least some embodiments described herein.

The system 300 may be similar to the crowd monitoring and control system 200 described above, and may be configured to monitor crowds and/or locations where crowds are gathered or expected to gather. The system 300 may include at least one capture device 302 configured to capture still images or video streams associated with the crowds and/or locations. The capture device(s) 302 may transmit the captured image/video data to a first server 304. The first server 304 may be configured to receive the captured image/video data and identify visible physical barriers and individuals. For example, the first server 304 may implement a barrier detection module 306 configured to identify physical barriers such as walls, columns, or other obstacles to movement of the individuals in the captured data. The first server 304 may also implement a human detection module 308 configured to identify individuals in the captured data. For example, the human detection module 308 may use computer vision features to detect moving features in the video stream data, and may identify the moving features as particular individuals.

The first server 304 may then transmit the barrier information from the barrier detection module 306 and the crowd member information from the human detection module 308 to a server 314. In some embodiments, the server 314 may also receive location maps data 312 and other location-specific data from a map database 310, which may be local to the server 314, remote to the server 314, and/or on a remote server. The location maps data 312 may include information about the locations monitored by the system 300, and the other location-specific data may include information about the identity and estimated locations and movement of individuals within the crowd, security personnel, and/or other personnel expected to be within the monitored locations.

The server 314 may be configured to generate and/or update a crowd model 316 based on the barrier information, the crowd member information from the first server 304, the captured data captured by the capture device(s) 302, and/or the location maps data 312. In some embodiments, the server 314 may generate the crowd model 316 using a best-fit evaluation model. For example, the crowd model 316 may be determined based on the various forces acting on one or more individuals in the crowd. The forces may include a self-drive force associated with the desired destination of the individual, mechanical crowd forces (for example, physical forces due to interaction with other individuals, such as via pushing), social interaction forces (for example, a desire of the individual to follow or stay away from certain other individuals), a barrier force based on interaction with physical barriers, and/or any other suitable force. Other crowd modeling approaches may be used, such as those based on particle models, Kalman filters, statistical models, diffusion models, or any other model that takes crowd information as an input and produces prediction information regarding crowd motion. As crowds may change over time, the server 314 may be configured to update or regenerate the crowd model 316 periodically or dynamically based on determined crowd conditions. In other embodiments, instead of generating the crowd model 316 the server 314 may receive the crowd model 316 from another server or external entity.

The server 314 may also be configured to determine crowd flow characteristics based on the crowd model 316. For example, the server 314 may include a crowd flow determination module 318 configured to receive the crowd model 316 and determine one or more crowd flows representing the movements of the various groups modeled in the crowd model 316. In some embodiments, the server 314 may also be configured to determine desired or optimal crowd flows, for example based on current crowd conditions and/or events, and may compare the desired crowd flows with the modeled crowd flows. The server 314 may then determine one or more potential actions based on differences between the modeled crowd flows and the desired crowd flows.

The server 314 may then provide the determined crowd flows and optionally the crowd model 316 to a server 320, which may be configured to provide guidance to individuals within a crowd. The server 320 may be configured to receive a guidance request relating to a device 326 associated with an individual in the crowd or a guidance application 330 executing on the device 326. The guidance request may include identity information for the device 326 and/or its associated individual, location information about where the individual is and/or the individual's desired destination, orientation information about the facing of the device 326, still images or video streams captured by the device 326, and/or any other suitable information. The server 320 may then use the received guidance request, the determined crowd flows, the crowd model 316, image/video data from the capture device(s) 302 and/or the device 326, and/or any other suitable information to identify one or more targets that the individual could move toward or follow in order to reach the desired destination. A guidance request may also originate within the crowd management system or with a third party such as an event or facility operator cognizant of appropriate routing.

The server 320 may include a target identification module 322 configured to identify one or more individuals in the crowd that are moving or predicted to move toward the desired destination. In some embodiments, the server 320 may be configured to extract one or more computer vision features associated with the identified target(s). For example, the server 320 may include a feature extraction module 324. The feature extraction module 324 may be configured to receive identified target information from the target identification module 322 and image/video data from the capture device(s) and/or the device 326, and may extract one or more computer vision features from the image/video data based on the target information. In some embodiments, the feature extraction module 324 may be configured to extract features that are usefully invariant with different perspectives, scales, and/or angles of view, such that the extracted features can be readily identified in still images and video streams taken at different orientations and at different locations within the crowd. For example, the features may include speeded up robust features (SURF) features, scale invariant feature transform (SIFT) features, histogram of oriented gradients (HOG) features, and/or any other suitable computer vision feature. The server 320 may then transmit the extracted features to the device 326 and/or the guidance application 330.

The device 326, as described above, may be associated with an individual in the crowd and configured to execute a guidance application 330. The guidance application 330 may be installed on the device 326 by the device manufacturer, or may be installed or loaded after device manufacture by the associated individual or another individual, for example via a link to an application store. In some embodiments, an event organizer or the event space may provide a way for individuals to identify and/or load the guidance application 330. For example, the event organizer or space may have an associated webpage that contains a hyperlink that allows individuals to load the guidance application 330. As another example, the event space may include displays for some sort of optical code (for example, a barcode, QR-code, or similar) that allows a camera-equipped device to identify and load the guidance application 330.

When an individual associated with the device 326 decides to request guidance, the individual may cause the device 326 and/or the guidance application 330 to send a guidance request to the server 320. The guidance application 330 may generate the guidance request based on information associated with the individual and/or the device 326 as described above, such as identity information, location information, orientation information, captured image/video data, and/or any other suitable information. For example, the device 326 may include a capture device (e.g. a camera) configured to capture image/video data 328, and the guidance application 330 may be configured to include the image/video data 328 in the guidance request.

The server 320 may then process the guidance request and transmit one or more extracted features to the guidance application 330, as described above. The guidance application 330 may then attempt to identify the extracted feature(s) in the image/video data 328. For example, the guidance application 330 may include a feature finding module 332 configured to find the extracted feature(s) in the image/video data 328. Once one or more of the feature(s) have been detected, the guidance application 330 may add one or more indicators corresponding to the detected feature(s) to the image/video data 328. For example, the guidance application 330 may include a tagging module 334 configured to add indicator(s) to the image/video data 328 to form tagged image/video data 336. The indicator(s) may include arrows, labels, shapes, text, and/or any other suitable visual indicator compatible with the image/video data 336. The tagged image/video data 336 may then be displayed to the individual associated with the device 326 for guidance.

As the crowd model 316, actual crowd flows, and desired crowd flows may change over time, the servers 314 and 320 may be configured to periodically or as conditions dictate update crowd flow information and guidance information. For example, the server 320 may be configured to periodically update the targets that an individual seeking guidance can follow, and may periodically re-extract computer vision features based on the updated target information and updated image/video data. The server 230 may then transmit the re-extracted computer vision features to the guidance application 330, which may then re-tag image/video data used as guidance. Similarly, in some situations the guidance request may change, due to movement of the individual and/or a change in desired destination. In such situations, the server 320 may also update the targets that the individual can follow, re-extract computer vision features based on the updated target information, and transmit the features to the guidance application 330.

While the system 300 is depicted as including at least three different servers 304, 314, and 320, in other embodiments the functionality of the servers 304, 314, and 320 may be divided among fewer or more servers or other computing devices. Similarly, while in the system 300 certain servers implement certain modules, in other embodiments modules may be implemented by other computing devices, across multiple computing devices, or be combined into a single module. For example, in some embodiments the target identification module 322 may be combined with the feature extraction module 324.

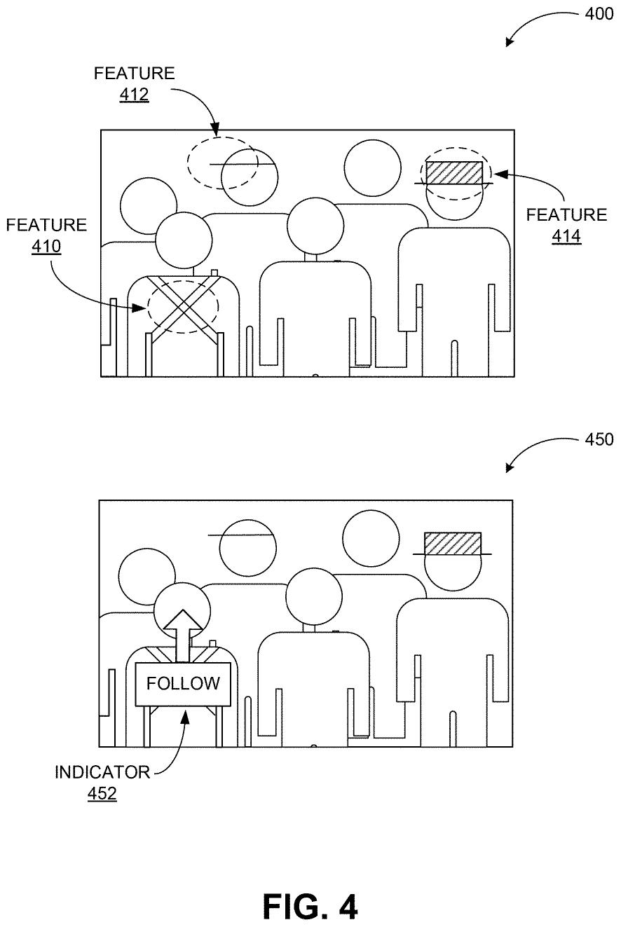

FIG. 4 depicts conceptually how features may be used to identify and tag individuals within a crowd to use as guides, arranged in accordance with at least some embodiments described herein.

FIG. 4 depicts a first image 400 of individuals within a crowd, which may be captured by a device such as the capture device 302 or the device 326. When the first image 400 is processed with a feature extraction or finding module (for example, the feature extraction module 324 or the feature finding module 332), one or more computer vision features 410, 412, and 414 may be identified. Each of the features 410, 412, and 414 may be associated with one or more individuals present in the first image 400. While the features shown conceptually are human-interoperable, in practice computer vision features are often not entire or single articles of clothing or items. Computer vision features are often an opportunistic collection of lines, gradients, or other mathematically representable elements within a field of view and many computer vision features may be meaningless to human eyes. Computer features provided for guidance may be any number from one to a large collection and in some cases guidance may be determined by observing a minimum number out of a larger collection of features.

As a result of a guidance request from a first individual, a crowd monitoring and control system similar to the system 300 may extract one or more features associated with target(s) that are moving toward a desired destination of the first individual, as described above. The system may then transmit the extracted feature(s) to the first individual, for example via a guidance application such as the guidance application 330 executing on a device associated with the individual. The guidance application may then determine whether any of the extracted feature(s) are present in images captured by the device. For example, suppose that the system determines that the feature(s) 410 or a second individual associated with the feature 410 is a target that is moving toward a desired destination of the first individual. The system may transmit data representative of the feature(s) 410 to the guidance application executing on the device associated with the first individual. The guidance application may then attempt to determine whether one or more of the feature(s) 410 are present in its captured image data, for example via a feature finding module such as the feature finding module 332. Upon determining that one or more feature(s) 410 are present, the guidance application may then tag the feature 410 in the first image 400, for example using a tagging module 334, by adding an indicator 452 to the feature 410 to result in a tagged image 450. The tagged image 450 may then be displayed to the first individual as guidance.

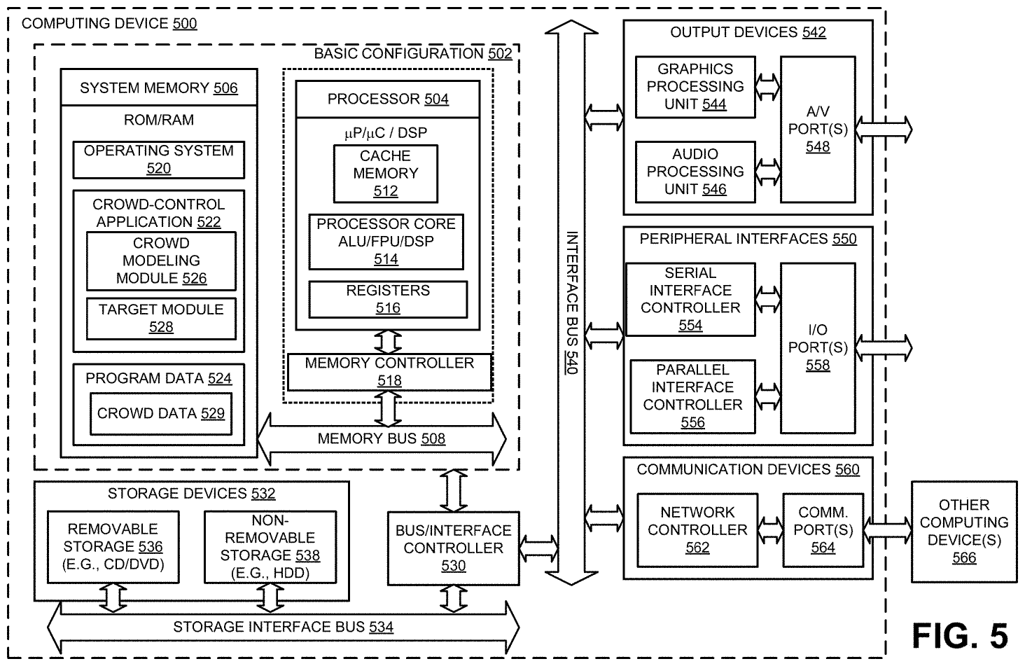

FIG. 5 illustrates a general purpose computing device, which may be used to provide guidance to individuals within a crowd, arranged in accordance with at least some embodiments described herein.

For example, the computing device 500 may be used to provide guidance to individuals within a crowd as described herein. In an example basic configuration 502, the computing device 500 may include one or more processors 504 and a system memory 506. A memory bus 508 may be used to communicate between the processor 504 and the system memory 506. The basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof. The processor 504 may include one more levels of caching, such as a cache memory 512, a processor core 514, and registers 516. The example processor core 514 may include an arithmetic logic unit (ALU), a floating point unit (FPU), a digital signal processing core (DSP Core), or any combination thereof. An example memory controller 518 may also be used with the processor 504, or in some implementations the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, a crowd-control application 522, and program data 524. The crowd-control application 522 may include a crowd modeling module 526 and a target module 528 to generate crowd models and identify target features as described herein. The program data 524 may include, among other data, crowd data 529 or the like, as described herein.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices include magnetic disk devices such as flexible disk drives and hard-disk drives (HDD), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (e.g., one or more output devices 542, one or more peripheral interfaces 550, and one or more communication devices 560) to the basic configuration 502 via the bus/interface controller 530. Some of the example output devices 542 include a graphics processing unit 544 and an audio processing unit 546, which may be configured to communicate to various external devices such as a display or speakers via one or more A/V ports 548. One or more example peripheral interfaces 550 may include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 560 includes a network controller 562, which may be arranged to facilitate communications with one or more other computing devices 566 over a network communication link via one or more communication ports 564. The one or more other computing devices 566 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a part of a general purpose or specialized server, mainframe, or similar computer that includes any of the above functions. The computing device 500 may also be implemented as a personal computer including both laptop computer and non-laptop computer configurations.

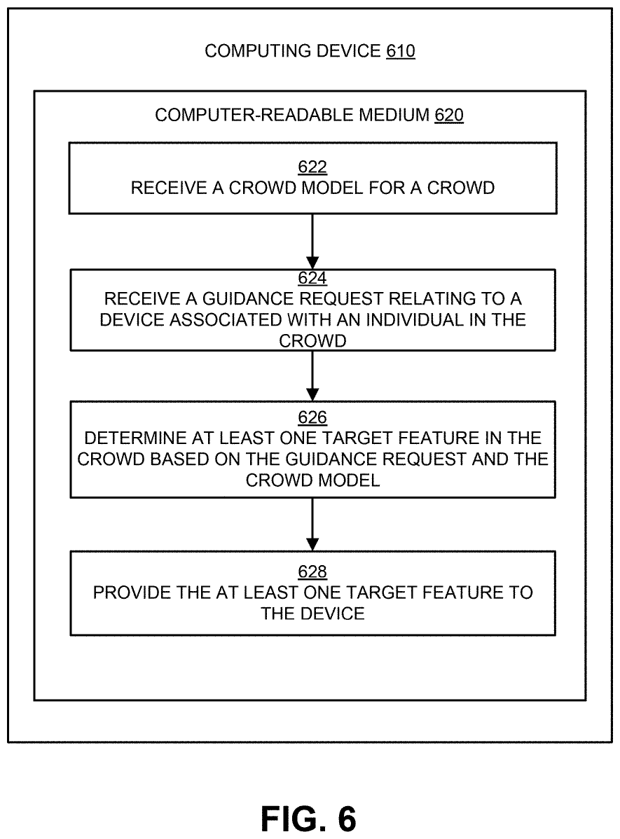

FIG. 6 is a flow diagram illustrating an example method to provide guidance to individuals within a crowd that may be performed by a computing device such as the computing device in FIG. 5, arranged in accordance with at least some embodiments described herein.

Example methods may include one or more operations, functions or actions as illustrated by one or more of blocks 622, 624, 626, and/or 628, and may in some embodiments be performed by a computing device such as the computing device 600 in FIG. 6. The operations described in the blocks 622-628 may also be stored as computer-executable instructions in a computer-readable medium such as a computer-readable medium 620 of a computing device 610.

An example process to provide guidance to individuals within a crowd may begin with block 622, “RECEIVE A CROWD MODEL FOR A CROWD”, where a crowd control and monitoring system such as the system 300 may receive or generate a crowd model for a crowd. For example, the system may receive the crowd model from another system or entity, or may generate the crowd model based on inputs as described above in FIG. 3.

Block 622 may be followed by block 624, “RECEIVE A GUIDANCE REQUEST RELATING TO A DEVICE ASSOCIATED WITH AN INDIVIDUAL IN THE CROWD”, where the crowd control and monitoring system may receive a guidance request relating to a device associated with an individual in the crowd or a guidance application executing on the device, as described above. The guidance request may include identity information, location information, image/video data, and/or any other information relevant to the guidance request.

Block 624 may be followed by block 626, “DETERMINE AT LEAST ONE TARGET FEATURE IN THE CROWD BASED ON THE GUIDANCE REQUEST AND THE CROWD MODEL”, where the crowd control and monitoring system may determine, based on the guidance request and the crowd model, one or more targets that may satisfy the guidance request. For example, the system may identify one or more targets that are moving toward a desired destination of the individual requesting guidance. In some embodiments, the target(s) may correspond to computer vision features extracted from captured image/video data, as described above.

Block 626 may be followed by block 628, “PROVIDE THE AT LEAST ONE TARGET FEATURE TO THE DEVICE”, where the system may transmit the extracted feature(s) to the device associated with the individual requesting guidance, as described above.

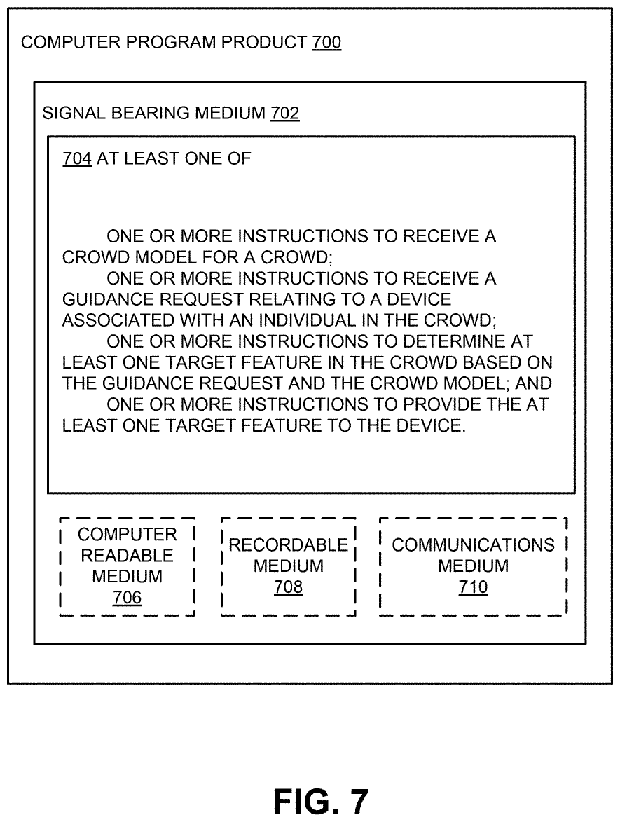

FIG. 7 illustrates a block diagram of an example computer program product, arranged in accordance with at least some embodiments described herein.

In some examples, as shown in FIG. 7, a computer program product 700 may include a signal bearing medium 702 that may also include one or more machine readable instructions 704 that, when executed by, for example, a processor may provide the functionality described herein. Thus, for example, referring to the processor 504 in FIG. 5, the crowd-control application 522 may undertake one or more of the tasks shown in FIG. 7 in response to the instructions 704 conveyed to the processor 504 by the signal bearing medium 702 to perform actions associated with providing guidance to individuals within a crowd as described herein. Some of those instructions may include, for example, instructions to receive a crowd model for a crowd, receive a guidance request relating to a device associated with an individual in the crowd, determine at least one target feature in the crowd based on the guidance request and the crowd model, and/or provide the at least one target feature to the device, according to some embodiments described herein.

In some implementations, the signal bearing medium 702 depicted in FIG. 7 may encompass computer readable medium 706, such as, but not limited to, a hard disk drive (HDD), a solid state drive (SSD), a compact disc (CD), a digital versatile disk (DVD), a digital tape, memory, etc. In some implementations, the signal bearing medium 702 may encompass recordable medium 708, such as, but not limited to, memory, read/write (R/W) CDs, R/W DVDs, etc. In some implementations, the signal bearing medium 702 may encompass communications medium 710, such as, but not limited to, a digital and/or an analog communication medium (e.g., a fiber optic cable, a waveguide, a wired communications link, a wireless communication link, etc.). Thus, for example, the computer program product 700 may be conveyed to one or more modules of the processor 504 by an RF signal bearing medium, where the signal bearing medium 702 is conveyed by the communications medium 710 (e.g., a wireless communications medium conforming with the IEEE 802.11 standard).

According to some examples, a method to provide guidance to individuals for crowd control is provided. The method may include receiving a crowd model for a crowd, receiving a guidance request related to a device associated with an individual in the crowd, determining at least one target feature in the crowd based on the guidance request and the crowd model, and providing the at least one target feature to the device.

According to some embodiments, the device may be configured to capture image data and the guidance request may include the image data and/or video data relating to the device. The device may be a smart phone, a video camera, a wearable computer, a tablet computer, or an augmented reality display device. The guidance request may include location data and/or orientation data relating to the device. The target feature(s) may be a computer vision feature substantially invariant with respect to different perspectives, scales, and angles of view, and may include a speeded up robust features (SURF) feature, a scale invariant feature transform (SIFT) feature, and/or a histogram of oriented gradients (HOG) feature. The target feature(s) may be associated with another individual in the crowd. In some embodiments, the method may further include determining an update including a crowd model update and/or a guidance request update, determine at least one other target feature in the crowd based on the update, and providing the other target feature(s) to the device.

According to other examples, a system to provide guidance to individuals for crowd control is provided. The system may include a communication module configured to exchange data with one or more computing devices, a memory configured to store instructions, and a processor coupled to the communication module and the memory. The processor may be configured to execute a crowd-control application in conjunction with the instructions stored in the memory. The crowd-control application may be configured to receive a crowd model for a crowd, receiving a guidance request relating to a device associated with a first individual in the crowd, determine a second individual in the crowd as a target based on the guidance request, the crowd model, and at least one feature associated with the second individual, and provide the at least one feature to the device.

According to some embodiments, the guidance request may include image data, video data, location data, and/or orientation data relating to the device. The feature(s) may be a computer vision feature substantially invariant with respect to different perspectives, scales, and angles of view, and may include a speeded up robust features (SURF) feature, a scale invariant feature transform (SIFT) feature, and/or a histogram of oriented gradients (HOG) feature. The crowd-control application may be further configured to determine an update including a crowd model update and/or a guidance request update, determine a third individual in the crowd as another target based on the update, determine at least one other feature associated with the third individual, and provide the other feature(s) to the device.

According to further examples, a mobile device configured to provide crowd navigation guidance to an individual is provided. The mobile device may include an imaging module configured to capture image data associated with the individual and a crowd, a memory configured to store instructions, and a processor coupled to the imaging module and the memory. The processor may be configured to execute a guidance application in conjunction with the instructions stored in the memory. The guidance application may be configured to send a request for crowd guidance to a crowd control system, receive feature data from the crowd control system, determine at least one feature in the image data based on the received feature data, and display at least one indicator based on the determined feature(s).

According to some embodiments, the mobile device may be a smart phone, a video camera, a wearable computer, a tablet computer, or an augmented reality display device. The mobile device may further include a location module configured to determine location data and/or orientation data associated with the mobile device, and the request may include the location data and/or the orientation data. The image data may include a video stream. The feature(s) may be a computer vision feature substantially invariant with respect to different perspectives, scales, and angles of view, and may include a speeded up robust features (SURF) feature, a scale invariant feature transform (SIFT) feature, and/or a histogram of oriented gradients (HOG) feature. The guidance application may be further configured to add the indicator(s) to the image data by tagging another individual in the image data and display the image data with the indicator(s). The processor may be further configured to load the guidance application through scanning of a QR-code.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and/or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors to move and/or adjust components and/or quantities).

A data processing system may be implemented utilizing any suitable commercially available components, such as those found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g.,“a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method to provide guidance to individuals for crowd control, the method comprising:
receiving a crowd model for a crowd;
receiving a guidance request related to a device associated with an individual in the crowd;
identify a desired direction based on the guidance request and the crowd model;
determining at least one target feature associated with another individual in the crowd based on the guidance request and the crowd model; and
providing the at least one target feature to the device such that the individual is notified of the target feature to identify and follow the other individual in the desired direction.

2. The method of claim 1, wherein:
the device is configured to capture image data, and
the guidance request includes at least one of the image data and video data related to the device.

3. The method of claim 1, wherein the device is one of a smart phone, a video camera, a wearable computer, a tablet computer, and an augmented reality display device.

4. The method of claim 1, wherein the guidance request includes at least one of location data and orientation data relating to the device.

5. The method of claim 1, wherein the at least one target feature is a computer vision feature substantially invariant with respect to different perspectives, scales, and angles of view.

6. The method of claim 5, wherein the at least one feature includes at least one of a speeded up robust features (SURF) feature, a scale invariant feature transform (SIFT) feature, and a histogram of oriented gradients (HOG) feature.

7. (canceled)

8. The method of claim 1, further comprising:
receiving an update, the update including at least one of a crowd model update and a guidance request update;
determining at least one other target feature associated with a further individual in the crowd based on the update; and
providing the at least one other target feature to the device.

9. A system to provide guidance to individuals for crowd control, the system comprising:
a communication module configured to exchange data with one or more computing devices;
a memory configured to store instructions; and
a processor coupled to the communication module and the memory, the processor configured to execute a crowd-control application in conjunction with the instructions stored in the memory, wherein the crowd-control application is configured to:
receive a crowd model for a crowd;
receive a guidance request related to a device associated with a first individual in the crowd;
identify a desired direction based on the guidance request and the crowd model;
determine a second individual in the crowd as a target to guide the first individual in the desired direction based on the guidance request, the crowd model, and at least one feature associated with the second individual; and
provide the at least one feature to the device such that the first individual is notified of the at least one feature to identify and follow the second individual in the desired direction.

10. The system of claim 9, wherein the guidance request includes at least one of image data and video data relating to the device.

11. The system of claim 9, wherein the guidance request includes at least one of location data and orientation data related to the device.

12. The system of claim 9, wherein the at least one feature is a computer vision feature substantially invariant with respect to different perspectives, scales, and angles of view.

13. The system of claim 12, wherein the at least one feature includes at least one of a speeded up robust features (SURF) feature, a scale invariant feature transform (SIFT) feature, and a histogram of oriented gradients (HOG) feature.

14. The system of claim 9, wherein the crowd-control application is further configured to:
receive an update, the update including at least one of a crowd model update and a guidance request update;
determine a third individual in the crowd as another target based on the update;
determine at least one other feature associated with the third individual; and
provide the at least one other feature to the device.

15. A mobile device configured to provide crowd navigation guidance to an individual, the mobile device comprising:
an imaging module configured to capture image data associated with the individual and a crowd;
a memory configured to store instructions; and
a processor coupled to the imaging module and the memory, the processor configured to execute a guidance application in conjunction with the instructions stored in the memory, wherein the guidance application is configured to:
send a request for crowd guidance to a crowd control system;
receive, from the crowd control system, feature data associated with another individual in the crowd to guide the individual in a desired direction;
determine at least one feature in the image data based on the received feature data;
add at least one indicator to the image data by tagging the other individual in the image data based on the determined at least one feature; and
display the at least one indicator to identify the other individual.

16. The mobile device of claim 15, wherein the mobile device is one of a smart phone, a video camera, a wearable computer, a tablet computer, and an augmented reality display device.

17. The mobile device of claim 15, further comprising a location module configured to determine at least one of location data and orientation data associated with the mobile device, wherein the request includes at least one of the location data and orientation data.

18. The mobile device of claim 15, wherein the image data includes a video stream.

19. The mobile device of claim 15, wherein the at least one feature is a computer vision feature substantially invariant with respect to different perspectives, scales, and angles of view.

20. The mobile device of claim 19, wherein the at least one feature includes at least one of a speeded up robust features (SURF) feature, a scale invariant feature transform (SIFT) feature, and a histogram of oriented gradients (HOG) feature.

21. (canceled)

22. The mobile device of claim 15, wherein the processor is further configured to:
load the guidance application through scanning of a QR-code.
